(19) United States
(12) Patent Application Publication
(10) Pub. No.: US 2010/0209649 A1
(43) Pub. Date: Aug. 19, 2010

(54) Double-coated pressure sensitive adhesive sheet

(75) Inventors: Rie Kuwahara, Osaka (JP); Takahiro Nonaka, Osaka (JP); Noritsugu Daigaku, Osaka (JP); Masahiro Oura, Osaka (JP)

Correspondence Address: EDWARDS ANGELL PALMER & DODGE LLP, P.O. BOX 55874, BOSTON, MA, 02205, US

(73) Assignee: NITTO DENKO CORPORATION, Ibaraki-shi (JP)

(21) Appl. No.: 12/656,802

(22) Filed: Feb. 17, 2010

(30) Foreign Application Priority Data
Feb. 18, 2009 (JP) 2009-034791

(51) Int. Cl. B32B 27/32; B32B 33/00

(52) U.S. Cl. 428/41.3; 428/40.1

(57) ABSTRACT

Disclosed is a double-coated pressure-sensitive adhesive sheet which includes at least a pressure-sensitive adhesive unit including a plastic base film and, present on or above both surfaces thereof, pressure-sensitive adhesive layers; and non-silicone release liners present on both surfaces of the pressure-sensitive adhesive unit. The pressure-sensitive adhesive layers are each formed from an acrylic polymer containing, as essential monomer components, an alkyl (meth)acrylate whose alkyl moiety being a linear or branched-chain alkyl group having 2 to 14 carbon atoms and a polar-group-containing monomer. The pressure-sensitive adhesive unit has a thickness of 60 to 160 μm, and each of the two pressure-sensitive adhesive layers of the pressure-sensitive adhesive unit has a thickness of 20 μm or more. The adhesive sheet excels in processability and fittability around bumps and is usable for fixing a flexible printed circuit board or for fixing a hard disk drive component.

### BACKGROUND OF THE INVENTION

1. Field of the Invention

The present invention relates to double-coated pressure-sensitive adhesive sheets adopted to fix a flexible printed circuit board or to fix a hard disk drive component.

2. Description of the Related Art

Double-coated pressure-sensitive adhesive sheets (double-sided self-adhesive sheets) are currently generally used for the fixation of a flexible printed circuit board (hereinafter also referred to as “FPC”) typically to a cabinet in the manufacture of hard disk drives (magnetic recording systems; HDDs).

Examples of such double-coated pressure-sensitive adhesive sheets include one whose release liner has improved processability, causes less contamination, and induces less outgassing (see Japanese Patent No. 3901490); and one which is improved in thermal stability and processability (see Japanese Unexamined Patent Application Publication (JP-A) No. 2006-89564).

### SUMMARY OF THE INVENTION

However, even these double-coated pressure-sensitive adhesive sheets have been found to suffer from the following problems. Specifically, the double-coated pressure-sensitive adhesive sheets show insufficient processability when designed to have a so-called “base-less” structure using no base or carrier. On the other hand, such double-coated pressure-sensitive adhesive sheets may be designed to have a base-containing structure including a plastic base film and pressure-sensitive adhesive layers arranged thereon so as to improve the processability. When the base-supported (carrier-supported) double-coated pressure-sensitive adhesive sheets are applied to an adherend bearing a fine pattern (such as a circuit pattern) and thereby having fine bumps (minute steps) on its surface, they may not sufficiently fit and come into a narrow space between the pattern (traces) and may not satisfactorily fit around bumps. This causes a gap between the adherend and the pressure-sensitive adhesive layer. This problem occurs particularly when it is undesirable or difficult to apply a certain pressing force for the fixation of the double-coated pressure-sensitive adhesive sheets, namely, it occurs particularly when the affixation of the double-coated pressure-sensitive adhesive sheets to adherends is performed with a low pressing force.

After investigations to solve these problems, it was that thin double-coated pressure-sensitive adhesive sheets having thicknesses of about 50 μm can have improved fittability around bumps while maintaining satisfactory processability by reducing the thickness of the plastic base. However, even these double-coated pressure-sensitive adhesive sheets may not sufficiently fit around bumps when the bumps are large or when the pressing force to affix the sheet to an adherend is particularly low.

Accordingly, an object of the present invention is to provide a double-coated pressure-sensitive adhesive sheet that excels in processability, can satisfactorily fit around bumps, and is useful when adopted to fix a flexible printed circuit board and/or to fix a hard disk drive component.

After intensive investigations, the present inventors have found that a pressure-sensitive adhesive sheet having a specific thickness and including a plastic base film and pressure-sensitive adhesive layers each having a specific thickness and a specific composition can excel in processability and fit satisfactorily around bumps. The present invention has been made based on these findings.

Specifically, according to an embodiment of the present invention, there is provided a double-coated pressure-sensitive adhesive sheet for fixing a flexible printed circuit board, the adhesive sheet includes at least a pressure-sensitive adhesive unit including a plastic base film, a first pressure-sensitive adhesive layer present on or above one surface of the plastic base film and forming a first surface of the pressure-sensitive adhesive unit, and a second pressure-sensitive adhesive layer present on or above the other surface of the plastic base film and forming a second surface of the pressure-sensitive adhesive unit; a first non-silicone release liner present on the first surface of the pressure-sensitive adhesive unit; and a second non-silicone release liner present on the second surface of the pressure-sensitive adhesive unit. In the adhesive sheet, each of the first and second pressure-sensitive adhesive layers independently includes an acrylic polymer containing, as essential monomer components, one or more polar-group-containing monomers and one or more alkyl (meth)acrylates whose alkyl moiety being a linear or branched-chain alkyl group having 2 to 14 carbon atoms, the pressure-sensitive adhesive unit has a thickness of from 60 to 160 μm, and each of the first and second pressure-sensitive adhesive layers independently has a thickness of 20 μm or more.

According to another embodiment of the present invention, there is further provided a double-coated pressure-sensitive adhesive sheet for fixing a hard disk drive component. The adhesive sheet includes at least a pressure-sensitive adhesive unit including a plastic base film, a first pressure-sensitive adhesive layer present on or above one surface of the plastic base film and forming a first surface of the pressure-sensitive adhesive unit, and a second pressure-sensitive adhesive layer present on or above the other surface of the plastic base film and forming a second surface of the pressure-sensitive adhesive unit; a first non-silicone release liner present on the first surface of the pressure-sensitive adhesive unit; and a second non-silicone release liner present on the second surface of the pressure-sensitive adhesive unit. In the adhesive sheet, each of the first and second pressure-sensitive adhesive layers independently includes an acrylic polymer containing, as essential monomer components, one or more polar-group-containing monomers and one or more alkyl (meth)acrylates whose alkyl moiety being a linear or branched-chain alkyl group having 2 to 14 carbon atoms, the pressure-sensitive adhesive unit has a thickness of from 60 to 160 μm, and each of the first and second pressure-sensitive adhesive layers independently has a thickness of 20 μm or more.

Each of the first and second pressure-sensitive adhesive layers may independently have a thickness of from 20 to 60 μm.

Each of the first and second pressure-sensitive adhesive layers may independently have a gel fraction of from 10% to 60%.

The non-silicone release liners may be polyolefinic release liners.

The double-coated pressure-sensitive adhesive sheets according to embodiments of the present invention (these are hereinafter also simply referred to as “the double-coated pressure-sensitive adhesive sheets”) have satisfactory adhesiveness derived from the acrylic pressure-sensitive adhesive layers and induce less outgassing because they use non-silicone release liners. In addition to these excellent properties, the double-coated pressure-sensitive adhesive sheets also excel in processability and can fit around bumps satisfactorily, because they use a plastic base film and control the thicknesses of the pressure-sensitive adhesive unit and pressure-sensitive adhesive layers within specific ranges. These advantages improve the productivity and quality of products manufactured while fixing a flexible printed circuit board or a hard disk drive typically to a cabinet through any of the double-coated pressure-sensitive adhesive sheets.

### BRIEF DESCRIPTION OF THE DRAWINGS

These and other objects, features, and advantages of the present invention will be more fully understood from the following description of preferred embodiments with reference to the attached drawings, in which:

FIG. 1 is a schematic cross-sectional view of a double-coated pressure-sensitive adhesive sheet according to an embodiment of the present invention;

FIG. 2 is an explanatory drawing (schematic cross-sectional view) showing a multilayer structure of a flexible printed circuit board (FPC) used in the testing for fittability around bumps; and

FIG. 3 is an explanatory drawing (plan view seen from the base film layer side) showing how the FPC and a double-coated pressure-sensitive adhesive sheet (test sample) are arranged in the testing for fittability around bumps.

### DESCRIPTION OF THE PREFERRED EMBODIMENTS

The present invention will be illustrated further with reference to various embodiments and, where necessary, to the attached drawings. All numbers are herein assumed to be modified by the term “about.”

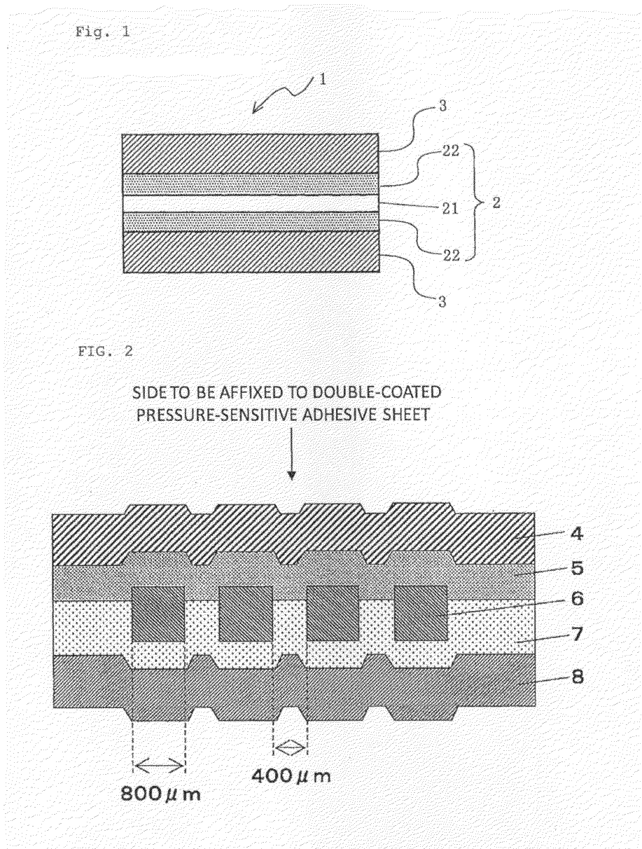

Double-coated pressure-sensitive adhesive sheets according to embodiments of the present invention include at least a pressure-sensitive adhesive unit; and non-silicone release liners present on or above both surfaces of the pressure-sensitive adhesive unit. The double-coated pressure-sensitive adhesive sheets therefore have at least a structure of (release liner)/(pressure-sensitive adhesive unit)/(release liner). FIG. 1 is a schematic cross-sectional view illustrating a double-coated pressure-sensitive adhesive sheet according to an embodiment of the present invention. The double-coated pressure-sensitive adhesive sheet 1 includes a pressure-sensitive adhesive unit (portion other than release liners) 2 and release liners 3 arranged on both surfaces of the pressure-sensitive adhesive unit 2. The pressure-sensitive adhesive unit 2 includes a plastic base film 21, and arranged on both sides thereof, pressure-sensitive adhesive layers 22. As used herein the term “double-coated pressure-sensitive adhesive sheet” also means and includes one in the form of a tape, i.e., a “double-coated pressure-sensitive adhesive tape”. As used herein the term “pressure-sensitive adhesive unit” refers to a portion of the double-coated pressure-sensitive adhesive sheet which portion is affixed to adherends upon use, i.e., it generally refers to a portion of the double-coated pressure-sensitive adhesive sheet other than release liners.

Pressure-Sensitive Adhesive Unit

The pressure-sensitive adhesive unit in the double-coated pressure-sensitive adhesive sheets has a multilayer structure including a plastic base film, and present on or above both surfaces thereof, pressure-sensitive adhesive layers, as described above. Specifically, the pressure-sensitive adhesive unit is a double-coated pressure-sensitive adhesive unit having both surfaces being adhesive faces (surfaces of pressure-sensitive adhesive layers). The pressure-sensitive adhesive unit herein may further include one or more other layers, such as intermediate layers and undercoating layers, within ranges not adversely affecting the advantages of the present invention. The plastic base film may be laminated with each of the pressure-sensitive adhesive layers directly, or indirectly with the interposition of one or more other layers such as intermediate layers.

The thickness of the pressure-sensitive adhesive unit is from 60 to 160 μm, preferably more than 60 μm and 160 μm or less, more preferably from 61 to 100 μm, and furthermore preferably from 61 to 80 μm. A pressure-sensitive adhesive unit having a thickness of more than 160 μm may cause the adhesive sheet to have insufficient processability. In contrast, one having a thickness of less than 60 μm may cause the adhesive sheet to have insufficient fittability typically around bumps especially when the affixation is performed at low bonding pressures (with low pressing force). As used herein the term “thickness of the pressure-sensitive adhesive unit” refers to a thickness (distance) from one adhesive face (surface of one of the pressure-sensitive adhesive layers) of the pressure-sensitive adhesive unit to the other adhesive face.

Plastic Base Film

The plastic base film in the pressure-sensitive adhesive unit of the double-coated pressure-sensitive adhesive sheets is a support for the pressure-sensitive adhesive layers and plays a role of improving the processability and handleability (handling properties) of the double-coated pressure-sensitive adhesive sheets. The plastic film can be one generally used as a support of a pressure-sensitive adhesive sheet. Exemplary plastic films include resinous films made from resins such as polyester resins, olefinic resins, poly(vinyl chloride) resins, acrylic resins, vinyl acetate resins, amide resins, polyimide resins, poly(ether ether ketone)s, and poly(phenylene sulfide)s. Among them, preferred are polyester films and polyolefin films, of which polyethylene terephthalate) (PET) films are more preferred from the viewpoints of cost and rigidity. The plastic base film for use herein may have a single-layer structure or multilayer structure.

To increase adhesion to the pressure-sensitive adhesive layers, the plastic base film may have been subjected to a common surface treatment according to necessity. Exemplary surface treatments include chromate treatment, exposure to ozone, exposure to a flame, exposure to a high-voltage electric shock, ionizing radiation treatment, and other chemical or physical oxidizing treatments. In addition or alternatively, the plastic base film may have been subjected to another treatment such as coating with a primer.

Though not critical, the thickness of the plastic base film is preferably from 2 to 100 μm, more preferably from 4 to 50 μm, and furthermore preferably from 4 to 25 μm. The plastic base film, if having a thickness of less than 2 μm, may impede the formation of pressure-sensitive adhesive layers thereon through direct application or may cause the double-coated pressure-sensitive adhesive sheet to have insufficient handleability. In contrast, the plastic base film, if having an excessively large thickness of more than 100 μm, may have excessively high rigidity, and the resulting double-coated pressure-sensitive adhesive sheet may not satisfactorily fit around bumps.

Pressure-Sensitive Adhesive Layers

The pressure-sensitive adhesive layers in the pressure-sensitive adhesive unit of the double-coated pressure-sensitive adhesive sheets are each formed from an acrylic polymer or polymers. Specifically, the pressure-sensitive adhesive layers each include one or more acrylic polymers as base polymers. Though not critical, the content of acrylic polymer or polymers (hereinafter referred to as “acrylic polymer component”) in each of the pressure-sensitive adhesive layers is preferably 80 percent by weight or more', and more preferably from 90 to 99 percent by weight.

Though not critical and may vary depending on the technique for the formation thereof, the pressure-sensitive adhesive layers may each be formed from an acrylic pressure-sensitive adhesive composition containing an acrylic polymer as an essential component; or an acrylic pressure-sensitive adhesive composition containing, as an essential component, a mixture of monomers for the formation of an acrylic polymer (hereinafter also referred to as a “monomer mixture”) or a partial polymer of the monomer mixture. Examples of the former composition include, but are not limited to, so-called solvent-based pressure-sensitive adhesive compositions, and examples of the latter composition include, but are not limited to, so-called active-energy-ray-curable pressure-sensitive adhesive compositions. The acrylic pressure-sensitive adhesive composition may further contain crosslinking agents and other various additives according to necessity.

As used herein the term “pressure-sensitive adhesive composition” also means and includes a “composition for the formation of the pressure-sensitive adhesive layers”. Also as used herein the term “monomer mixture” refers to a mixture composed of one or more monomer components for the formation of the acrylic polymer alone. The term “partial polymer” refers to a composition in which one or more of components constituting the monomer mixture have been partially polymerized.

The acrylic polymer component plays the role of developing adhesiveness (tackiness) as a base polymer of the pressure-sensitive adhesive layers. The acrylic polymer component is a copolymer formed from, as essential monomer components, one or more monomers each containing one or more alkyl (meth)acrylates whose alkyl moiety being a linear or branched-chain alkyl group having 2 to 14 carbon atoms (hereinafter also referred to as “(meth)acrylic C₂-C₁₄ alkyl ester(s)” and one or more monomers containing a polar group (hereinafter also referred to as “polar-group-containing monomer(s)”). The acrylic polymer component may further include, as monomer components, one or more additional monomer components in addition to the (meth)acrylic C₂-C₁₄ alkyl esters and polar-group-containing monomers. Each of the (meth)acrylic C₂-C₁₄ alkyl esters, each of the polar-group-containing monomers, and each of the additional monomer components may be used alone or in combination, respectively. As used herein the term “(meth)acrylic” refers to “acrylic” and/or “methacrylic”, and the same is true for other descriptions.

The (meth)acrylic C₂-C₁₄ alkyl esters are alkyl (meth)acrylates whose alkyl moiety being a linear or branched-chain alkyl group having 2 to 14 carbon atoms, and examples thereof include ethyl (meth)acrylates, propyl (meth)acrylates, isopropyl (meth)acrylates, butyl (meth)acrylates (n-butyl (meth)acrylates), isobutyl (meth)acrylates, s-butyl (meth)acrylates, t-butyl (meth)acrylates, pentyl (meth)acrylates, isopentyl (meth)acrylates, hexyl (meth)acrylates, heptyl (meth)acrylates, octyl (meth)acrylates, 2-ethylhexyl (meth)acrylates, isooctyl (meth)acrylates, nonyl (meth)acrylates, isononyl (meth)acrylates, decyl (meth)acrylates, isodecyl (meth)acrylates, undecyl (meth)acrylates, dodecyl (meth)acrylates, tridecyl (meth)acrylates, and tetradecyl (meth)acrylates. Of these, alkyl (meth)acrylates whose alkyl moiety being a linear or branched chain alkyl group having 2 to 10 carbon atoms are preferred, of which 2-ethylhexyl acrylate and n-butyl acrylate are more preferred.

The content of the (meth)acrylic C₂-C₁₄ alkyl esters is from 50 to 99 percent by weight, preferably from 80 to 97 percent by weight, and furthermore preferably from 90 to 95 percent by weight, based on the total amount (100 percent by weight) of monomer components for the formation of the acrylic polymer. An acrylic polymer, if having a content of (meth)acrylic C₂-C₁₄ alkyl esters of less than 50 percent by weight, may less tend to exhibit properties as an acrylic polymer, such as tackiness. In contrast, an acrylic polymer, if having a content of (meth)acrylic C₂-C₁₄ alkyl esters of more than 99 percent by weight, may exhibit insufficient adhesiveness due to excessively small content of polar-group-containing monomers.

The polar-group-containing monomers are monomers having at least one polar group per one molecule, of which ethylenically unsaturated monomers are preferred. Exemplary polar-group-containing monomers include carboxyl-containing monomers such as (meth)acrylic acids, itaconic acid, maleic acid, fumaric acid, crotonic acid, and isocrotonic acid, and acid anhydrides of them, such as maleic anhydride; hydroxyl-containing monomers including hydroxylalkyl (meth)acrylates such as 2-hydroxyethyl (meth)acrylates, 3-hydroxypropyl (meth)acrylates, 4-hydroxybutyl (meth)acrylates, and 6-hydroxyhexyl (meth)acrylates, as well as other hydroxyl-containing monomers such as vinyl alcohol and allyl alcohol; amido-containing monomers such as (meth)acrylamides, N,N-dimethyl(meth)acrylamides, N-methylol(meth)acrylamides, N-methoxymethyl(meth)acrylamides, N-butoxymethyl(meth)acrylamides, and N-hydroxyethylacrylamide; amino-containing monomers such as aminoethyl (meth)acrylates, dimethylaminoethyl (meth)acrylates, and t-butylaminoethyl(meth)acrylates; glycidyl-containing monomers such as glycidyl (meth)acrylates and methylglycidyl (meth)acrylates; cyano-containing monomers such as acrylonitrile and methacrylonitrile; heterocycle-containing vinyl monomers such as N-vinyl-2-pyrrolidone, (meth) acryloylmorpholines, N-vinylpyridine, N-vinylpiperidone, N-vinylpyrimidine, N-vinylpiperazine, N-vinylpyrrole, N-vinylimidazole, and N-vinyloxazole; sulfo-containing monomers such as sodium vinylsulfonate; phosphate-containing monomers such as 2-hydroxyethylacryloyl phosphate; imide-containing monomers such as cyclohexylmaleimide and isopropylmaleimide; and isocyanate-containing monomers such as 2-methacryloyloxyethyl isocyanate. Each of different polar-group-containing monomers can be used alone or in combination. Of the polar-group-containing monomers, carboxyl-containing monomers or acid anhydrides of them, and hydroxyl-containing monomers are preferred, of which acrylic acid (AA) and 4-hydroxybutyl acrylate (4HBA) are more preferred.

The content of the polar-group-containing monomers is preferably from 1 to 30 percent by weight, and more preferably from 3 to 20 percent by weight, based on the total amount (100 percent by weight) of monomer components for the formation of the acrylic polymer. An acrylic polymer, if having a content of polar-group-containing monomers of more than 30 percent by weight, may cause the acrylic pressure-sensitive adhesive layers to have an excessively high cohesive strength to thereby have insufficient tackiness. An acrylic polymer, if having a content of polar-group-containing monomers of less than 1 percent by weight, may cause the pressure-sensitive adhesive layers to have insufficient cohesive strengths to thereby, for example, to have insufficient shear bond strengths, and this may cause the double-coated pressure-sensitive adhesive sheet to have insufficient adhesiveness. Above all, the content of carboxyl-containing monomers or anhydrides of them (especially the content of acrylic acid) is preferably from 1 to 20 percent by weight, and more preferably from 3 to 10 percent by weight, based on the total amount (100 percent by weight) of monomer components for the formation of the acrylic polymer. These ranges are preferred from the viewpoint of adhesiveness. The content of hydroxyl-containing monomers (especially the content of 4HBA) is preferably from 0.01 to 10 percent by weight, and more preferably from 0.05 to 5 percent by weight, based on the total amount (100 percent by weight) of monomer components for the formation of the acrylic polymer. These ranges are preferred from the viewpoint of crosslinking properties.

The additional monomer components are monomers other than the (meth)acrylic C₂-C₁₄ alkyl esters and polar-group-containing monomers, of which ethylenically unsaturated monomers are preferred. Exemplary additional monomer components include methyl (meth)acrylates; alkyl (meth)acrylates whose alkyl moiety being linear or branched-chain alkyl group having 15 or more carbon atoms, such as pentadecyl (meth)acrylates, hexadecyl (meth)acrylates, heptadecyl (meth)acrylates, octadecyl (meth)acrylates, nonadecyl (meth)acrylates, and eicosyl (meth)acrylates; (meth)acrylic esters having an alicyclic hydrocarbon group, such as cyclopentyl (meth)acrylates, cyclohexyl (meth)acrylates, and isobornyl (meth)acrylates; aryl (meth)acrylates such as phenyl (meth)acrylates; vinyl esters such as vinyl acetate and vinyl propionate; aromatic vinyl compounds such as styrene and vinyltoluene; olefins or dienes such as ethylene, butadiene, isoprene, and isobutylene; vinyl ethers such as vinyl alkyl ethers; and vinyl chloride. Exemplary additional monomer components further include multifunctional monomers such as hexanediol di(meth)acrylates, butanediol di(meth)acrylates, (poly)ethylene glycol di(meth)acrylates, (poly) propylene glycol di(meth)acrylates, neopentyl glycol di(meth)acrylates, pentaerythritol di(meth)acrylates, pentaerythritol tri(meth)acrylates, dipentaerythritol hexa(meth)acrylates, trimethylolpropane tri(meth)acrylates, tetramethylolmethane tri(meth)acrylates, allyl (meth)acrylates, vinyl (meth)acrylates, divinylbenzene, epoxy acrylates, polyester acrylates, and urethane acrylates. Each of different monomer components can be used alone or in combination.

The acrylic polymer can be prepared by polymerizing (copolymerizing) the monomer components according to a known or common polymerization technique. Exemplary polymerization techniques for acrylic polymers include solution polymerization, emulsion polymerization, mass polymerization (bulk polymerization), and polymerization through the application of active energy rays such as ultraviolet rays. Of these techniques, solution polymerization and polymerization through the application of active energy rays are preferred to give a transparent, waterproof double-coated pressure-sensitive adhesive sheet at low cost. Upon polymerization of the acrylic polymer, suitable components chosen from among known or common ones according to the polymerization technique can be used. Exemplary components herein include polymerization initiators, chain-transfer agents, emulsifiers, and solvents.

One or more initiators may be used in the preparation of the acrylic polymer. The initiators may be chosen according to the type of the polymerization reaction from among thermopolymerization initiators and active-energy-ray polymerization initiators (hereinafter also referred to as “photopolymerization initiator(s)” or “photoinitiator(s)”). Each of different polymerization initiators can be used alone or in combination.

Examples of the photopolymerization initiators usable herein include, but are not limited to, benzoin ether photoinitiators, acetophenone photoinitiators, α-ketol photoinitiators, aromatic sulfonyl chloride photoinitiators, photoactive oxime photoinitiators, benzoin photoinitiators, benzil photoinitiators, benzophenone photoinitiators, ketal photoinitiators, and thioxanthone photoinitiators. Though not critical, the amount of photoinitiators is preferably from 0.01 to 0.2 part by weight, and more preferably from 0.05 to 0.15 part by weight, for example, per 100 parts by weight of the total amount of monomer components for the formation of the acrylic polymer.

Examples of the benzoin ether photoinitiators include benzoin methyl ether, benzoin ethyl ether, benzoin propyl ether, benzoin isopropyl ether, benzoin isobutyl ether, 2,2-dimethoxy-1,2-diphenylethan-1-one, and anisole methyl ether. Exemplary acetophenone photoinitiators include 2,2-diethoxyacetophenone, 2,2-dimethoxy-2-phenylacetophenone, 1-hydroxycyclohexyl phenyl ketone, 4-phenoxydichloroacetophenone, and 4-(t-butyl)dichloroacetophenone. Exemplary α-ketol photoinitiators include 2-methyl-2-hydroxypropiophenone, 1-[4-(2-hydroxyethyl)phenyl]-2-methylpropan-1-one. Exemplary aromatic sulfonyl chloride photoinitiators include 2-naphthalenesulfonyl chloride. Exemplary photoactive oxime photoinitiators include 1-phenyl-1,1-propanedione-2-(o-ethoxycarbonyl)-oxime. Exemplary benzoin photoinitiators include benzoin. Exemplary benzil photoinitiators include benzil. Exemplary benzophenone photoinitiators include benzophenone, benzoylbenzoic acid, 3,3′-dimethyl-4-methoxybenzophenone, polyvinylbenzophenone, and α-hydroxycyclohexyl phenyl ketone. Exemplary ketal photoinitiators include benzyl dimethyl ketal. Exemplary thioxanthone photoinitiators include thioxanthone, 2-chlorothioxanthone, 2-methylthioxanthone, 2,4-dimethylthioxanthone, isopropylthioxanthone, 2,4-diisopropylthioxanthone, and dodecylthioxanthone.

Examples of the thermopolymerization initiators include azo polymerization initiators; peroxide polymerization initiators such as dibenzoyl peroxide and tert-butyl permaleate; and redox polymerization initiators. Among them, the azo initiators disclosed in Japanese Unexamined Patent Application Publication (JP-A) No. 2002-69411 are particularly preferred. Such azo initiators are preferred because their decomposed products are unlikely to remain as components causing outgassing (outgassing induced by heating) in the acrylic polymer. Exemplary azo initiators include 2,2′-azobisisobutyronitrile (hereinafter also referred to as AIBN), 2,2′-azobis-2-methylbutyronitrile (hereinafter also referred to as AMBN), dimethyl 2,2′-azobis(2-methylpropionate), 4,4′-azobis(4-cyanovaleric acid), azobisisovaleronitrile, 2,2′-azobis(2-amidinopropane) dihydrochloride, 2,2′-azobis[2-(5-methyl-2-imidazolin-2-yl)propane) dihydrochloride, 2,2′-azobis(2-methylpropionamidine) disulfate, and 2,2′-azobis(N,N′-dimethyleneisobutylamidine) dihydrochloride. The amount of thermopolymerization initiators is preferably from 0.05 to 0.5 part by weight, and more preferably from 0.1 to 0.3 part by weight, per 100 parts by weight of the total amount of monomer components for the formation of the acrylic polymer.

Known or common organic solvents, for example, can be used in polymerization of the acrylic polymer through solution polymerization. Exemplary organic solvents usable herein include ester solvents such as ethyl acetate and methyl acetate; ketone solvents such as acetone and methyl ethyl ketone; alcohol solvents such as methanol, ethanol, and butanol; hydrocarbon solvents such as cyclohexane, hexane, and heptane; and aromatic solvents such as toluene and xylenes. Each of different organic solvents may be used alone or in combination.

The weight-average molecular weights of the acrylic polymers are preferably from 30×10⁴ to 200×10⁴, more preferably from 60×10⁴ to 150×10⁴, and furthermore preferably from 70×10⁴ to 150×10⁴. An acrylic polymer having a weight-average molecular weight of less than 30×10⁴ may not sufficiently help the pressure-sensitive adhesive layers to exhibit satisfactory tacky adhesive properties; and, in contrast, an acrylic polymer having a weight-average molecular weight of more than 200×10⁴ may impede satisfactory coating of the composition, both undesirable. The weight-average molecular weights can be controlled typically by modifying the types and amounts of polymerization initiators; the temperature and duration of the polymerization, and the concentrations and adding rates (dropping rates) of monomers in the polymerization.

The acrylic pressure-sensitive adhesive composition for the formation of the pressure-sensitive adhesive layers preferably further contains one or more crosslinking agents for the purpose typically of controlling the gel fraction (proportion of components insoluble in the solvent) of the pressure-sensitive adhesive layers. Exemplary crosslinking agents include isocyanate crosslinking agents, epoxy crosslinking agents, melamine crosslinking agents, peroxide crosslinking agents, urea crosslinking agents, metal alkoxide crosslinking agents, metal chelate crosslinking agents, metal salt crosslinking agents, carbodiimide crosslinking agents, oxazoline crosslinking agents, aziridine crosslinking agents, and amine crosslinking agents. Of these, isocyanate crosslinking agents are preferred as essential crosslinking agents, and more preferably, one or more isocyanate crosslinking agents are used in combination with one or more epoxy crosslinking agents. Each of different crosslinking agents can be used alone or in combination.

Examples of the isocyanate crosslinking agents include lower aliphatic polyisocyanates such as 1,2-ethylene diisocyanate, 1,4-butylene diisocyanate, and 1,6-hexamethylene diisocyanate; alicyclic polyisocyanates such as cyclopentylene diisocyanate, cyclohexylene diisocyanate, isophorone diisocyanate, hydrogenated tolylene diisocyanate, hydrogenated xylene diisocyanate, and hydrogenated xylylene diisocyanate; aromatic polyisocyanates such as 2,4-tolylene diisocyanate, 2,6-tolylene diisocyanate, 4,4′-diphenylmethane diisocyanate, and xylylene diisocyanate; as well as a trimethylolpropane/tolylene diisocyanate adduct [supplied by Nippon Polyurethane Industry Co., Ltd. under the trade name “CORONATE L”], and a trimethylolpropane/hexamethylene diisocyanate adduct [supplied by Nippon Polyurethane Industry Co., Ltd. under the trade name “CORONATE HL”].

Examples of the epoxy crosslinking agents include N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ethers, polyethylene glycol diglycidyl ethers, polypropylene glycol diglycidyl ethers, sorbitol polyglycidyl ethers, glycerol polyglycidyl ethers, pentaerythritol polyglycidyl ethers, polyglycerol polyglycidyl ethers, sorbitan polyglycidyl ethers, trimethyloipropane polyglycidyl ethers, diglycidyl adipate, diglycidyl o-phthalate, triglycidyl-tris(2-hydroxyethyl) isocyanurate, resorcinol diglycidyl ether, bisphenol-S-diglycidyl ether, and epoxy resins having two or more epoxy groups per one molecule. Exemplary commercial products usable as epoxy crosslinking agents include a product supplied by Mitsubishi Gas Chemical Company, Inc. under the trade name “TETRAD C”.

In an acrylic pressure-sensitive adhesive composition containing an acrylic polymer component as an essential component, the content of crosslinking agents is preferably from 0.15 to 1.05 parts by weight, more preferably from 0.2 to 1.05 parts by weight, and furthermore preferably from 0.2 to 0.5 part by weight, per 100 parts by weight of the acrylic polymer component.

Above all, the content of isocyanate crosslinking agents is preferably from 0.15 to 1 part by weight, more preferably from 0.2 to 1 part by weight, and furthermore preferably from 0.2 to 0.5 part by weight, per 100 parts by weight of the acrylic polymer component. If the content of isocyanate crosslinking agents is less than 0.15 part by weight, the pressure-sensitive adhesive layers may show an insufficient anchoring activity to adherends, and this may cause “lifting” when the double-coated pressure-sensitive adhesive sheet is heated after affixed to the adherends. In contrast, if it exceeds 1 part by weight, the pressure-sensitive adhesive layers may have excessively high gel fractions to have excessively high repulsive force against bending, and this may cause “lifting” when the double-coated pressure-sensitive adhesive sheet is heated after affixed to the adherends.

Isocyanate crosslinking agents, if contained in a relatively low content (e.g. 0.5 part by weight or less), may not sufficiently help the pressure-sensitive adhesive layers to have controlled gel fractions, because most of isocyanate crosslinking agents undergo crosslinking by themselves. In this case, one or more epoxy crosslinking agents are preferably used in combination with the isocyanate crosslinking agents. The content of epoxy crosslinking agents is preferably from 0 to 0.05 part by weight, and more preferably from 0 to 0.02 part by weight, per 100 parts by weight of the acrylic polymer component. If the content of epoxy crosslinking agents exceeds 0.05 part by weight, the pressure-sensitive adhesive layers may have excessively high gel fractions to have a high repulsive force against bending, and this may cause “lifting” when the double-coated pressure-sensitive adhesive sheet is heated after affixed to the adherends.

In an acrylic pressure-sensitive adhesive composition-containing a monomer mixture or a partial polymer thereof as an essential component, preferred ranges of the contents of crosslinking agents are indicated by replacing the above-mentioned base “100 parts by weight of the acrylic polymer component” with “per 100 parts by weight of the total amount of monomer components for the formation of the acrylic polymer”. Specifically, the content of crosslinking agents in the acrylic pressure-sensitive adhesive composition is preferably from 0.15 to 1.05 parts by weight, more preferably from 0.2 to 1.05 parts by weight, and furthermore preferably from 0.2 to 0.5 part by weight, per 100 parts by weight of the total amount of monomer components for the formation of the acrylic polymer. Above all, the content of isocyanate crosslinking agents is preferably from 0.15 to 1 part by weight, more preferably from 0.2 to 1 part by weight, and furthermore preferably from 0.2 to 0.5 part by weight, per 100 parts by weight of the total amount of monomer components for the formation of the acrylic polymer. The content of epoxy crosslinking agents is preferably from 0 to 0.05 part by weight, and more preferably from 0 to 0.02 part by weight, per 100 parts by weight of the total amount of monomer components for the formation of the acrylic polymer.

The acrylic pressure-sensitive adhesive composition may further contain known additives, in addition to the essential component (the acrylic polymer component, or monomer mixture or a partial polymer thereof), according to necessity within ranges not adversely affecting the properties obtained according to the present invention. The pressure-sensitive adhesive layers in the double-coated pressure-sensitive adhesive sheet may therefore independently further contain any of such additive components. Exemplary additives herein include polymerization initiators, age inhibitors, fillers, colorants (such as pigments and dyestuffs), ultraviolet-absorbers, antioxidants, plasticizers, softeners, surfactants, and antistatic agents.

The acrylic pressure-sensitive adhesive composition may be in the form of a solution in any of common solvents. Such solvents are not limited in type and can be any of the solvents listed to be used in the solution polymerization of the acrylic polymer.

The acrylic pressure-sensitive adhesive composition preferably contains substantially no tackifier resin from the viewpoint of suppressing outgassing. The term “contains substantially no” refers to that the component in question is not actively incorporated, except for being inevitably contaminated. Accordingly, the pressure-sensitive adhesive layers in the double-coated pressure-sensitive adhesive sheet preferably contain substantially no tackifier resin. Specifically, the content of tackifier resins in the pressure-sensitive adhesive layers is preferably less than 1 percent by weight, and more preferably less than 0.1 percent by weight, based on the total weight of the pressure-sensitive adhesive layers. A tackifier resin, if contained in the acrylic pressure-sensitive adhesive composition and pressure-sensitive adhesive layers may cause outgassing when the pressure-sensitive adhesive layers are heated. Exemplary tackifier resins include rosin derivative resins, polyterpene resins, petroleum resins, and oil-soluble phenolic resins.

The way to form the pressure-sensitive adhesive layers of the double-coated pressure-sensitive adhesive sheet is not particularly limited and may be suitably selected from among known techniques for forming pressure-sensitive adhesive layers, whereas the way may vary depending on the polymerization process of the base polymer (acrylic polymer). Specifically but merely by way of example, the pressure-sensitive adhesive layers may be formed according to the following techniques.

In the case of, for example, an acrylic pressure-sensitive adhesive composition (such as an acrylic pressure-sensitive adhesive composition solution) containing an acrylic polymer as an essential component, the pressure-sensitive adhesive layers may be formed by a direct application process of applying the acrylic pressure-sensitive adhesive composition to a predetermined surface (such as a surface of a plastic base film) so as to have a predetermined thickness after drying, and drying and/or curing the applied composition according to necessity; or by a transfer process of applying the acrylic pressure-sensitive adhesive composition to a suitable release liner so as to have a predetermined thickness after drying, drying and/or curing the applied composition according to necessity to form a pressure-sensitive adhesive layer, and transferring the formed pressure-sensitive adhesive layer to a predetermined surface such as a surface of the plastic base film.

In the case of an acrylic pressure-sensitive adhesive composition containing a mixture of monomer components for the formation of the acrylic polymer (monomer mixture) or a partial polymer of the monomer mixture as an essential component, the pressure-sensitive adhesive layers may be formed by a direct application process of applying the acrylic pressure-sensitive adhesive composition to a predetermined surface such as a surface of the plastic base film and applying an active energy ray to cure the composition by the action of the active energy ray to thereby form a pressure-sensitive adhesive layer; or a transfer process of applying the acrylic pressure-sensitive adhesive composition to a suitable release liner, applying an active energy ray thereto to cure the composition by the action of the active energy ray to thereby form a pressure-sensitive adhesive layer, and transferring the formed pressure-sensitive adhesive layer to a predetermined surface such as a surface of the plastic base film. Where necessary, the pressure-sensitive adhesive layer may further be dried.

The application (coating) of the acrylic pressure-sensitive adhesive composition in the formation of the pressure-sensitive adhesive layers can be performed according to a known coating technique using a common coater. Exemplary coaters include gravure roll coaters, reverse roll coaters, kiss-roll coaters, dip roll coaters, bar coaters, knife coaters, roll knife coaters, spray coaters, and direct coaters.

The pressure-sensitive adhesive unit in the double-coated pressure-sensitive adhesive sheet can be prepared by forming pressure-sensitive adhesive layers on or above both sides of the plastic base film according to any of the techniques for forming pressure-sensitive adhesive layers as above.

The thickness of each of the pressure-sensitive adhesive layers (thickness of a layer on one side of the pressure-sensitive adhesive layers) in the pressure-sensitive adhesive unit of the double-coated pressure-sensitive adhesive sheets is 20 μm or more, preferably from 20 to 60 μm, and furthermore preferably from 22 to 50 μm. Specifically, one pressure-sensitive adhesive layer (first pressure-sensitive adhesive layer) present on one side of the plastic base film in the pressure-sensitive adhesive unit has a thickness of 20 μm or more; and the other pressure-sensitive adhesive layer (second pressure-sensitive adhesive layer) present on the other side of the plastic base film also has a thickness of 20 μm or more. If at least one of the pressure-sensitive adhesive layers has a thickness of less than 20 μm, the double-coated pressure-sensitive adhesive sheet may insufficiently fit around bumps, and may insufficiently fit especially around large bumps or insufficiently fit around bumps after the affixation with a low pressing force. This is because the thickness of the pressure-sensitive adhesive unit herein is as large as 60 μm or more, and thereby the thicknesses of the pressure-sensitive adhesive layers are relatively thin. In contrast, if the thickness of each pressure-sensitive adhesive layer is excessively large of more than 60 μm, the double-coated pressure-sensitive adhesive sheet may show insufficient processability. Each of the pressure-sensitive adhesive layers may independently have a single-layer structure or multilayer structure.

The gel fractions of the pressure-sensitive adhesive layers in the pressure-sensitive adhesive unit of the double-coated pressure-sensitive adhesive sheet are preferably from 10% to 60% (percent by weight), more preferably from 10% to 50%, and furthermore preferably from 15% to 50%. Control of the gel fractions of the pressure-sensitive adhesive layers within this range makes the double-coated pressure-sensitive adhesive sheet resistant to “lifting” from an adherend even when the sheet is affixed to adherends and then subjected to a heating process. The pressure-sensitive adhesive layers, if having gel fractions of less than 10%, may have insufficient cohesive force and become susceptible to a cohesive failure, and this may cause insufficient adhesiveness and reworkability (e.g., prevention of an adhesive transfer upon peeling) of the sheet, thus being undesirable. In contrast, the pressure-sensitive adhesive layers, if having gel fractions of more than 60%, may have excessively high repulsive force against bending and may often cause “lifting” typically in bumped portions during or after a heating process, thus being undesirable. The gel fractions may be controlled, for example, by modifying the monomer composition of the acrylic polymer and/or the types and contents of crosslinking agents.

The gel fractions (contents of insoluble matter in solvents) are determined, for example, according to the following “technique for measuring gel fraction”.

Technique for Measuring Gel Fraction

About 0.1 g of a pressure-sensitive adhesive layer of the double-coated pressure-sensitive adhesive sheet is sampled, the sample is covered by a porous tetrafluoroethylene sheet (supplied by Nitto Denko Corporation under the trade name “NTF 1122”) having an average pore size of 0.2 μm, tied with a kite string, the weight of the resulting article is measured, and this weight is defined as a “weight before immersion”. The “weight before immersion” is the total weight of the pressure-sensitive adhesive layer (the sampled pressure-sensitive adhesive layer), the tetrafluoroethylene sheet, and the kite string. Independently, the total weight of the tetrafluoroethylene sheet and the kite string is measured as a tare weight.

Next, the sampled pressure-sensitive adhesive layer covered by the tetrafluoroethylene sheet and tied with the kite stirring (hereinafter also referred to as “sample”) is placed in a 50-ml vessel filled with ethyl acetate, and left stand at 23° C. for one week (7 days). The sample after immersion in ethyl acetate is retrieved from the vessel, transferred into an aluminum cup, dried in a drier at 130° C. for 2 hours to remove ethyl acetate, and the weight of the resulting sample is measured as a weight after immersion.

A gel fraction is calculated according to the following equation:

Gel fraction (percent by weight)=(A−B)/(C−B)×100 (1)

wherein “A” represents the weight after immersion; “B” represents the tare weight; and “C” represents the weight before immersion.

Release Liners

The surfaces (adhesive faces) of the pressure-sensitive adhesive layers of the double-coated pressure-sensitive adhesive sheet are protected by release liners (separators). Specifically, the two adhesive faces of the double-coated pressure-sensitive adhesive sheet are protected by two different release liners respectively (one release liner protects one adhesive face). The release liners for use in the double-coated pressure-sensitive adhesive sheet are non-silicone release liners using no silicone release agent. Silicone release liners, if used, may allow their component silicon compounds to be attached to the adhesive faces or to be adsorbed by the pressure-sensitive adhesive layers, and the silicon compounds may evolve siloxane gas or may cause contamination of the adherend. This may cause corrosion and/or contact failure of electronic components in the products, such as hard disc drives, manufactured while fixing a FPC or hard disk drive component through the double-coated pressure-sensitive adhesive sheet. Non-silicone release liners do not cause these problems and are advantageously used herein. The release liners are used as protecting members for the pressure-sensitive adhesive layers and will be removed when the double-coated pressure-sensitive adhesive sheet is affixed to adherends.

The non-silicone release liners are not particularly limited, unless they use silicone release agents. Exemplary non-silicone release liners include base materials having a releasable layer; low-adhesive base materials made from fluorine-containing polymers; and low-adhesive base materials made from nonpolar polymers. Exemplary base materials having a releasable layer include plastic films and papers whose surface has been treated with a release agent such as a long-chain alkyl release agent, a fluorine-containing release agent, or molybdenum sulfide. Exemplary fluorine-containing polymers in the low-adhesive base materials made from fluorine-containing polymers include polytetrafluoroethylenes, polychlorotrifluoroethylenes, poly(vinyl fluoride)s, poly(vinylidene fluoride)s, tetrafluoroethylene/hexafluoropropylene copolymers, and chlorofluoroethylene/vinylidene fluoride copolymers. Exemplary nonpolar polymers in the low-adhesive base materials made from nonpolar polymers include olefinic resins such as polyethylenes and polypropylenes.

Of these non-silicone release liners, preferred are release liners (polyolefinic release liners) having a film layer on the releasable surface made from an olefinic resin (polyolefinic resin), of which release liners (polyethylenic release liners) having a film layer on the releasable surface made from a polyethylene are especially preferred. The polyolefin release liners have only to have an olefinic resin layer to be a surface (releasable surface) in contact with an adhesive face, and may be, for example, a multilayer film including a polyester resin layer and an olefinic resin layer.

The olefinic resins are not especially limited, but preferred examples thereof include polyethylenes, of which linear low-density polyethylenes and low-density polyethylenes are more preferred; polypropylenes; polybutenes; poly(4-methyl-1-pentene)s; and ethylene-α-olefin copolymers (copolymers of ethylene and an α-olefin having 3 to 10 carbon atoms). Among them, more preferred are resin mixtures each containing at least two ethylenic polymers selected from the group consisting of a linear low-density polyethylene, a low-density polyethylene, and an ethylene-α-olefin copolymer. Of such resin mixtures containing at least two ethylenic polymers, those containing at least a linear low-density polyethylene are preferred, and those containing a linear low-density polyethylene in combination with a low-density polyethylene and/or ethylene-α-olefin copolymer are more preferred.

A comonomer component for use with ethylene in the linear low-density polyethylenes can be chosen adequately but is preferably 1-hexene and/or 1-octene. Of the ethylene-α-olefin copolymers, preferred examples include ethylene-propylene copolymers and ethylene-(1-butene) copolymers.

The release liners can be formed according to a known or common procedure. The thicknesses and other dimensions or properties of the release liners are not critical.

It is preferred in the double-coated pressure-sensitive adhesive sheets that the release force between the pressure-sensitive adhesive unit and one release liner present on one adhesive face of the pressure-sensitive adhesive unit differs from the release force between the pressure-sensitive adhesive unit and the other release liner present on the other adhesive face, because this improves the workability such as workability in peeling of the release liners. The release force between the pressure-sensitive adhesive unit and the release liner on a side with a less release force (more peelable side) (hereinafter referred to as “release force of the more peelable side”) is preferably from 0.01 to 0.3 newtons per 50 millimeters (N/50 mm), more preferably from 0.05 to 0.3 N/50 mm, and furthermore preferably from 0.1 to 0.3 N/50 mm. On the other hand, the release force between the pressure-sensitive adhesive unit and the release liner on a side with a more release force (less peelable side) (hereinafter referred to as “release force of the less peelable side”) is preferably from 0.1 to 2 N/50 mm, and more preferably from 0.5 to 1 N/50 mm. The difference between the release force of the more peelable side and that of the less peelable side (difference in release force) is preferably 0.05 N/50 mm or more, and more preferably from 0.1 to 1 N/50 mm. The difference in release force is represented by the formula: [(release force of the less peelable side)-(release force of the more peelable side)]. As used herein the term “release force” refers to a 180-degree peel strength (180-degree peel adhesion) of the release liner with respect to the pressure-sensitive adhesive unit as measured in a 180-degree peel test in accordance with Japanese Industrial Standards (JIS) Z0237.

Exemplary factors to control the release forces include the surface roughness (arithmetic mean surface roughness) of the release layer surface (the surface of the side to be in contact with the adhesive face of the pressure-sensitive adhesive unit) of the release liners, and the types of the release agents.

Exemplary preferred release liners for use as the more peelable side include polyolefin release liners having a release layer (releasable layer) made from an olefinic resin and having a rough or embossed surface, such as the release liner described in Japanese Unexamined Patent Application Publication (JP-A) No. 2005-350650. The rough surface of the release layer preferably includes embossed or roughened portions with irregularly different shapes arranged in an irregular positional relationship. Though not critical, the surface roughness (arithmetic mean surface roughness) Ra of the release layer is, for example, preferably from 0.5 to 5 μm, more preferably from 1 to 3 μm, and furthermore preferably from 1.5 to 2 μm. These ranges are preferred typically from the viewpoints of the releasability and airtightness between the release layer and the pressure-sensitive adhesive layer. Also though not critical, the maximum surface roughness amplitude Rt of the release layer is, for example, preferably from 1 to 15 μm, more preferably from 0.3 to 10 μm, and furthermore preferably from 4 to 8 μm.

In contrast, exemplary preferred release liners for use as the less peelable side include polyolefin release liners having a release layer without such a rough surface, such as the release liner described in Japanese Patent No. 3901490.

Properties of Double-Coated Pressure-Sensitive Adhesive Sheets

The double-coated pressure-sensitive adhesive sheets exhibit satisfactory “fittability around bumps”, because the pressure-sensitive adhesive layers have relatively large thicknesses, and the ratio of the thicknesses of the pressure-sensitive adhesive layers to the thickness of the plastic base film is relatively large. The term “fittability around bumps” (also referred to as “bump absorptivity”) refers to such a property that the pressure-sensitive adhesive sheets easily and satisfactorily fit the bumps (rough shapes) of adherends when the sheets are affixed to the adherends. As having satisfactory fittability around bumps, the double-coated pressure-sensitive adhesive sheets show improved adhesiveness even to an adherend having a fine pattern (traces), such as a FPC, even when the double-coated pressure-sensitive adhesive sheets are affixed to the adherend with a weak pressing force. This is because the pressure-sensitive adhesive layers can readily fit and enter even narrow spaces between the traces (lines). The double-coated pressure-sensitive adhesive sheets excel especially in fittability around bumps when affixed under a low bonding pressure (with a low pressing force) and, in addition, they can fit even large bumps to thereby exhibit high reliability in adhesion. This is because each of the pressure-sensitive adhesive layers has a relatively large thickness of 20 μm or more. If the pressure-sensitive adhesive layers have small absolute thicknesses, the double-coated pressure-sensitive adhesive sheets may not sufficiently fit around bumps when affixed to the adherends under a very small bonding pressure (with a very small pressing force) such as a bonding pressure of from 0.1 to 0.5 MPa even if the relative thicknesses of the pressure-sensitive adhesive layers to the thickness of the plastic base film are set large.

The double-coated pressure-sensitive adhesive sheets have satisfactory processability because of having a plastic base film. As used herein the term “processability” refers to workability when the double-coated pressure-sensitive adhesive sheets are punched or cut into predetermined shapes. Such satisfactory processability refers typically to that, when the double-coated pressure-sensitive adhesive sheets are half-cut, in which only one release liner and the pressure-sensitive adhesive unit are notched, and stored for a long time, there occurs no autohesion between cut surfaces.

The double-coated pressure-sensitive adhesive sheets also satisfactorily avoid outgassing (low outgas emission). Though not critical, the double-coated pressure-sensitive adhesive sheets each have an outgassing (total outgassing: total amount of evolved outgases) of preferably 1 microgram per square centimeter (μg/cm²) or less, more preferably 0.8 μg/cm² or less, and furthermore preferably 0.4 μg/cm² or less. The outgassing herein is determined while heating a sample sheet at a temperature of 120° C. for 10 minutes and measuring the total amount of evolved outgases according to the following measuring technique. Specifically, the two release liners (first and second release liners) are both removed from the double-coated pressure-sensitive adhesive sheet to expose adhesive faces; a poly(ethylene terephthalate) (PET) film as a backing is affixed to one adhesive face of the pressure-sensitive adhesive unit; and the amount of outgases evolved from the other adhesive face bearing no backing is measured. A double-coated pressure-sensitive adhesive sheet showing an outgassing of 1 μg/cm² or less does not cause corrosion and malfunction of electronic devices, such as hard disk drives, due to outgas components and is superior in long-term reliability even when it is adopted to fix a FPC or hard disk drive component in the electronic devices. These outgases are generally derived from silicone release agents in release liners and unreacted monomer components in pressure-sensitive adhesive layers. Thus, outgassing can be reduced in the present invention, for example, by using non-silicone release liners. The outgassing can also be reduced typically by controlling, within preferred ranges, the types and molecular weights of polymerization initiators for the acrylic polymer for use in the pressure-sensitive adhesive layers. It is preferred that the outgassing falls within the above-specified range when any of the two adhesive faces of the double-coated pressure-sensitive adhesive sheet is subjected to the measurement.

Exemplary Technique for Measurement of Outgassing

The outgassing can be measured, for example, according to the following technique.

One of the two release liners is removed from the double-coated pressure-sensitive adhesive sheet to expose an adhesive face, and a poly(ethylene terephthalate) film (supplied by Toray Industries, Inc. under the trade name “Lumirror S-10″, 25 μm thick) is affixed to the exposed adhesive face. The double-coated pressure-sensitive adhesive sheet bearing the PET film affixed on one side thereof is cut into a piece of 1 cm wide and 7 cm long, from which the other release liner is removed, to give a test specimen.

The test specimen is heated at 120° C. for 10 minutes in a purge and trap headspace sampler, an evolved gas is trapped, and the trapped components are analyzed with gas chromatograph/mass spectrometer. The amount of evolved gas (outgassing) is converted in terms of n-decane, and the outgassing is calculated as the amount of outgas per unit area (in unit of μg/cm²).

The double-coated pressure-sensitive adhesive sheets preferably have gel fractions controlled within a range of from 10% to 60%. The control helps the double-coated pressure-sensitive adhesive sheets to be resistant to “lifting” (lifting of the double-coated pressure-sensitive adhesive sheets from adherends) even when affixed to the adherends and thereafter heated or warmed. In general, double-coated pressure-sensitive adhesive sheets having bases such as plastic base films show large repulsive force against bending and tend to suffer from the “lifting”. However, the control of the gel fractions helps the double-coated pressure-sensitive adhesive sheets to have a reduced repulsive force or to have an increased bond strength against repulsive force to thereby suppress the “lifting”. Specifically, the double-coated pressure-sensitive adhesive sheets have split distances as measured in the following manner of preferably 1.5 mm or less, and more preferably from 0.1 to 1 mm. The split distance is determined in the following manner: A test specimen is prepared by affixing one adhesive face of a sample double-coated pressure-sensitive adhesive sheet (10 mm wide and 90 mm long) to one entire surface of an aluminum sheet 0.5 mm thick, 10 mm wide, and 90 mm long; the test specimen is bent in a longitudinal direction thereof into an arc along a round rod having a diameter of 50 mm so that the pressure-sensitive adhesive sheet faces outward; and the other adhesive face of the double-coated pressure-sensitive adhesive sheet in the test specimen is affixed to an adherend through compression bonding, where the adherend is a flat plate prepared by affixing a polyimide film to a polypropylene sheet 2 mm thick, and the other adhesive face is affixed to the polyimide film of the adherend; the resulting article is left stand at 23° C. for 24 hours, thereafter heated or warmed at 70° C. for 2 hours, and the height (mm) of an end of the test specimen lifted or raised from the adherend surface is measured and defined as “split distance” (mm). More specifically, the split distances can be measured by the technique described in “(3) Split Distance (at 70° C. for 2 hours)” in “Evaluations” mentioned below. It is preferred that the split distances fall within the above range when any of the two adhesive faces of the double-coated pressure-sensitive adhesive sheet is affixed to the aluminum plate to be measured.

The double-coated pressure-sensitive adhesive sheets according to embodiments of the present invention include a double-coated pressure-sensitive adhesive sheet adopted to fix a component in the manufacture of a hard disk drive (double-coated pressure-sensitive adhesive sheet for fixing a hard disk drive component) and a double-coated pressure-sensitive adhesive sheet adopted to fix a flexible printed circuit board (FPC) to an adherend (double-coated pressure-sensitive adhesive sheet for fixing a flexible printed circuit board). The double-coated pressure-sensitive adhesive sheets are advantageously usable in these applications where adherends have bumps derived from conductors or interconnections, because they excel in processability and fittability around bumps. The double-coated pressure-sensitive adhesive sheets can give high-quality products, such as hard disk drives, with satisfactory reliability in the above applications, because they use non-silicone release liners and thereby do not cause contamination of adherends, especially of electronic components, derived from silicone release liners. According to an embodiment, the double-coated pressure-sensitive adhesive sheets cause less “lifting”. In this case, the “lifting” of the sheets from adherends such as FPCs due typically to bumps derived from conductors or interconnections are suppressed even after a certain process such as baking (e.g., at a heating temperature of about 90° C.) for curing the resin is performed.

Exemplary components of hard disk drives (hard disk drive components) herein include FPCs, metallic plates or sheets, resin films, metallic foils, multilayer films of a metal and a resin film, labels, and motors.

Exemplary adherends to be fixed to a FPC through the double-coated pressure-sensitive adhesive sheet include, but are not limited to, cellular phone cabinets, motors, bases, substrates, and covers. Affixation (fixation) of a FPC to the adherend through the double-coated pressure-sensitive adhesive sheet gives, for example, hard disk drives, cellular phones, and motors.

Though not limited, the flexible printed circuit board (FPC) may include an electrical insulating (dielectric) layer (hereinafter also referred to as a “base insulating layer”), an electroconductive layer (hereinafter also referred to as a “conductive layer”) arranged as a predetermined circuit pattern on or above the base insulating layer, and, where necessary, a covering electrical insulating layer (hereinafter also referred to as a “cover insulating layer”) arranged on or above the conductive layer. The flexible printed circuit board may have a multilayer structure in which two or more circuit substrates are stacked.

The base insulating layer is an electrical insulating layer prepared from an electrically insulating material. The electrically insulating material to form the base insulating layer is not especially limited and can be suitably chosen from among electrically insulating materials for use in known flexible printed circuit boards. Preferred examples of such electrically insulating materials are plastic materials such as polyimide resins, acrylic resins, poly(ether nitrile) resins, poly(ether sulfone) resins, polyester resins (e.g., poly(ethylene terephthalate)s and poly(ethylene naphthalate)s), poly(vinyl chloride) resins, poly(phenylene sulfide) resins, poly(ether ether ketone) resins, polyamide resins (e.g., so-called “aramid resins”), polyarylate resins, polycarbonate resins, and liquid crystal polymers. Each of different electrically insulating materials can be used alone or in combination. Among them, polyimide resins are more preferred. The base insulating layer may have a single-layer structure or multilayer structure. The surface of the base insulating layer may have been subjected to one or more surface treatments such as corona discharge treatment, plasma treatment, surface roughening, and hydrolyzing. Though not critical, the thickness of the base insulating layer is preferably from 3 to 100 μm, more preferably from 5 to 50 μm, and furthermore preferably from 10 to 30 μm.

The conductive layer is an electroconductive layer prepared from an electroconductive material. The conductive layer is arranged to form a predetermined circuit pattern on or above the base insulating layer. The electroconductive material to form the conductive layer is not especially limited and can be suitably chosen from among electroconductive materials for use in known flexible printed circuit boards. Exemplary electroconductive materials include metallic materials such as copper, nickel, gold, and chromium, as well as alloys (for example, solder) and platinum; and electroconductive plastic materials. Each of different electroconductive materials can be used alone or in combination. Among them, metallic materials are preferred, of which copper is especially preferred. The conductive layer may have a single-layer structure or multilayer structure. The surface of the conductive layer may have been subjected to one or more surface treatments. Though not critical, the thickness of the conductive layer is preferably from 1 to 50 μm, more preferably from 2 to 30 μm, and furthermore preferably from 3 to 20 μm.

The way to form the conductive layer is not especially limited and can be chosen from among known formation techniques for conductive layers, including known patterning processes such as subtractive process, additive process, and semi-additive process. Typically, when to be arranged directly on the surface of the base insulating layer, the conductive layer can be provided by forming a layer of an electroconductive material as a predetermined circuit pattern on the base insulating layer typically through plating or vapor deposition. Exemplary techniques usable herein include electroless plating, electrolytic plating, vacuum vapor deposition, and sputtering.

The cover insulating layer is a covering electrical insulating layer (protective electrical insulating layer) which is prepared from an electrically insulating material and covers the conductive layer. The cover insulating layer is provided according to necessity and is not necessarily provided. The electrically insulating material to form the cover insulating layer is not especially limited and can be chosen from among electrically insulating materials for use in known flexible printed circuit boards, as in the base insulating layer. Specific examples of electrically insulating materials for the formation of the cover insulating layer include the electrically insulating materials listed above as the electrically insulating materials for the formation of the base insulating layer. Among them, plastic materials are preferred, of which polyimide resins are more preferred, as in the base insulating layer. Each of different electrically insulating materials can be used alone or in combination for the formation of the cover insulating layer. The cover insulating layer may have a single-layer structure or multilayer structure. The surface of the cover insulating layer may have been subjected to one or more surface treatments such as corona discharge treatment, plasma treatment, surface roughening, and hydrolyzing. Though not critical, the thickness of the cover insulating layer is preferably from 3 to 100 μm, more preferably from 5 to 50 μm, and furthermore preferably from 10 to 30 μm.

The way to form the cover insulating layer is not especially limited and can be suitably chosen from among known formation techniques. Exemplary formation techniques include a technique of applying a layer of a liquid or melt containing an electrically insulating material, and drying the applied layer; and a technique of previously forming a film or sheet corresponding to the dimensions of the conductive layer and containing an electrically insulating material, and laying the film or sheet on the conductive layer.

### EXAMPLES

The present invention will be illustrated in further detail with reference to several examples below. It should be noted, however, that these are illustrated only by way of example and are never construed to limit the scope of the present invention.

### Example 1

A solution (solids concentration: 25 percent by weight) of an acrylic polymer (hereinafter referred to as “Acrylic Polymer 1”) having a weight-average molecular weight of 150×10⁴ was prepared by subjecting 93 parts by weight of butyl acrylate, 7 parts by weight of acrylic acid, and 0.05 part by weight of 4-hydroxybutyl acrylate to solution polymerization according to a common procedure while using ethyl acetate as a solvent and 0.1 part by weight of azobisisobutyronitrile as an initiator. The solution was combined with 0.2 part by weight (in terms of solids content) of an isocyanate crosslinking agent and 0.01 part by weight of an epoxy crosslinking agent per 100 parts by weight of the acrylic polymer and thereby yielded a solution of pressure-sensitive adhesive composition (solution of acrylic pressure-sensitive adhesive composition). The isocyanate crosslinking agent was a product supplied by Nippon Polyurethane Industry Co., Ltd. under the trade name “CORONATE L” as a tolylene diisocyanate adduct of trimethylolpropane and had a solids concentration of 75 percent by weight. The epoxy crosslinking agent was a product supplied by Mitsubishi Gas Chemical Company, Inc. under the trade name “TETRAD C”.

In Table 1, the “amount (part by weight)” of the isocyanate crosslinking agent (CORONATE L) is indicated as the “amount (part by weight) in terms of solids content of CORONATE L per 100 parts by weight of the acrylic polymer”; and the “amount (part by weight)” of the epoxy crosslinking agents (TETRAD C) is indicated as the “amount (part by weight) of TETRAD C itself (the whole quantity of the product) per 100 parts by weight of the acrylic polymer”.

The above-prepared solution of pressure-sensitive adhesive composition was applied to both surfaces of a poly(ethylene terephthalate) film (supplied by Toray Industries, Inc. under the trade name “Lumirror S-10”, 12 μm thick), dried at 120° C. for 3 minutes to form pressure-sensitive adhesive layers, and thereby yielded a pressure-sensitive adhesive unit having a thickness of 60 μm. The thickness herein is the thickness from the surface of one pressure-sensitive adhesive layer to the surface of the other pressure-sensitive adhesive layer. Each of the two pressure-sensitive adhesive layers had a thickness of 24 μm. The gel fractions of the pressure-sensitive adhesive layers are as shown in Table 1. In this connection, the two pressure-sensitive adhesive layers had an equal gel fraction to each other.

A release liner (release liner “a”) was prepared in the following manner. Initially, a solution of anchor coating agent (primer) was prepared by blending 100 parts by weight of an ester urethane anchor coating agent (supplied by Toyo-Morton, Ltd. under the trade name “AD-527”) with 7 parts by weight of a curing accelerator (supplied by Toyo-Morton, Ltd. under the trade name “CAT HY-91”) and thereafter adding ethyl acetate to give a solution having a solids concentration of 5 percent by weight. The solution of anchor coating agent was applied to a poly(ethylene terephthalate) film (supplied by Toray Industries, Inc. under the trade name “Lumirror S-105-50”, 50 μm thick) using a roll coater to form a layer about 1 μm thick, and the applied layer was dried at 80° C. to give an anchor coating layer 0.1 μm thick. A layer of low-density polyethylene (supplied by Asahi Kasei Corporation under the trade name “L-1850A”) was extruded and laminated onto the anchor coating layer through extrusion at a temperature below the die of 325° C. according to a tandem system to give an undercoat layer 10 μm thick. Independently, a resin composition was prepared by mixing 100 parts by weight of a resin mixture containing a linear low-density polyethylene as a principal component (supplied by Prime Polymer Co., Ltd. under the trade name “MORETEC (registered trademark) 0628D”) with 150 parts by weight of an ethylene-propylene copolymer (supplied by Mitsui Chemicals, Inc. under the trade name “TAFMER (registered trademark) P0180”). Subsequently, a layer of the resin composition (release layer component) was extruded and laminated onto the undercoat layer through extrusion at a temperature below the die of 273° C. to give a release layer 10 μm thick, and the extruded release layer was finely embossed by cooling the layer using an embossed cooling mat roll as a cooling roll to give a release layer having an embossed or roughened surface (surface-embossed release layer). Thus, a release liner (release liner “a”) having a total thickness of about 70 μm was prepared.

The embossed surface of the surface-embossed release layer includes embossed or roughened portions with irregularly different shapes arranged in an irregular positional relationship. The surface-embossed release layer had an arithmetic mean surface roughness (Ra) of 1.5 μm and a maximum surface roughness amplitude (Rt) of 4 μm.

Independently, another release liner (release liner “b”) was prepared in the following manner. Initially, a solution of anchor coating agent (primer) was prepared by blending 100 parts by weight of an ester urethane anchor coating agent (supplied by Toyo-Morton, Ltd. under the trade name “AD-527”) with 7 parts by weight of a curing accelerator (supplied by Toyo-Morton, Ltd. under the trade name “CAT HY-91”) and thereafter adding ethyl acetate to give a solution having a solids concentration of 5 percent by weight. The solution of anchor coating agent was applied to a poly(ethylene terephthalate) film (supplied by Toray Industries, Inc. under the trade name “Lumirror S-105-50”, 50 μm thick) using a roll coater to give a layer about 1 μm thick, and the applied layer was dried at 80° C. to give an anchor coating layer 0.1 μm thick. A layer of low-density polyethylene (supplied by Asahi Kasei Corporation under the trade name “L-1850A”) was extruded and laminated onto the anchor coating layer through extrusion at a temperature below the die of 325° C. according to a tandem system to give an undercoat layer 10 μm thick. Independently, a resin composition was prepared by mixing 100 parts by weight of a resin mixture containing a linear low-density polyethylene as a principal component (supplied by Prime Polymer Co., Ltd. under the trade name “MORETEC (registered trademark) 0628D”) with 10 parts by weight of an ethylene-propylene copolymer (supplied by Mitsui Chemicals, Inc. under the trade name “TAFMER (registered trademark) P0180”). Subsequently, a layer of the resin composition (release layer component) was extruded and laminated onto the undercoat layer through extrusion at a temperature below the die of 273° C. to give a release layer 10 μm thick. Thus, the release liner (release liner “b”) having a total thickness of about 70 μm was prepared.

Next, the release liner “a” (more peelable side) was applied to one adhesive face of the pressure-sensitive adhesive unit, and the release liner “b” (less peelable side) was applied to the other adhesive face so that the releasable layers (release layers) were in contact with the adhesive faces, respectively, and thereby yielded a double-coated pressure-sensitive adhesive sheet.

### Example 2, Comparative Examples 2 and 3

A series of double-coated pressure-sensitive adhesive sheets was prepared by the procedure of Example 1, except for modifying the thickness of a poly(ethylene terephthalate) film used as the plastic base film, and modifying the thicknesses of the pressure-sensitive adhesive layers as given in Table 1.

### Example 3

A double-coated pressure-sensitive adhesive sheet was prepared by the procedure of Example 1, except for modifying the amounts of the crosslinking agents, the thickness of a poly(ethylene terephthalate) film used as the plastic base film, and thicknesses of the pressure-sensitive adhesive layers as given in Table 1.

### Comparative Example 1

A solution (solids concentration: 20 percent by weight) of an acrylic polymer (hereinafter also referred to as “Acrylic Polymer 2”) having a weight-average molecular weight of 100×10⁴ was prepared by subjecting 90 parts by weight of 2-ethylhexyl acrylate and 10 parts by weight of acrylic acid to solution polymerization according to a common procedure using ethyl acetate as a solvent and 0.5 part by weight of benzoyl peroxide as an initiator. The solution was combined with 2 parts by weight (in terms of solids content) of an isocyanate crosslinking agent (supplied by Nippon Polyurethane Industry Co., Ltd. under the trade name “CORONATE L”) per 100 parts by weight of the acrylic polymer, to give a solution of pressure-sensitive adhesive composition (solution of acrylic pressure-sensitive adhesive composition).

A release liner used herein was a release liner (release liner “c”) including a glassine paper, and on surface thereof, a releasable layer formed from a silicone release agent.

Next, a base-less (transfer; double-sided) pressure-sensitive adhesive sheet was prepared by forming a pressure-sensitive adhesive layer and applying two plies of the release liner “c” to both sides of the pressure-sensitive adhesive layer, as shown in Table 1. Specifically, the double-sided pressure-sensitive adhesive sheet was prepared in the following manner. A layer of the above-prepared solution of pressure-sensitive adhesive composition was applied to the releasable surface (releasable layer surface) of the release liner “c”, and the applied layer was dried at 120° C. for 3 minutes to give a pressure-sensitive adhesive layer 50 μm thick. In this article, the release liner plays a role as a less peelable side. Thereafter another ply of the release liner “c” (as a more peelable side) was applied to the other adhesive face of the pressure-sensitive adhesive layer opposite to the former release liner “c” so that the releasable layer was in contact with the adhesive face to give the double-coated pressure-sensitive adhesive sheet.

Evaluations

The double-coated or double-sided pressure-sensitive adhesive sheets prepared according to the examples and comparative examples were subjected to measurements and evaluations according to methods described below. The results of measurements and evaluations are shown in Table 1.

(1) Adhesive Strength (180-Degree Peel, with Respect to SUS 304-BA Stainless Steel)

Strip specimens each 20 mm wide and 150 mm long were prepared from the double-coated or double-sided pressure-sensitive adhesive sheets prepared according to the examples and comparative examples.

The specimens were subjected to a 180-degree peel test using a tensile tester according to the method specified in JIS 20237 to measure a 180-degree peel strength (N/20 mm) from a test plate (SUS 304-BA stainless steel plate), and the measured 180-degree peel strength was defined as the “adhesive strength”.

The affixation of the specimen to the test plate was conducted in the following manner: the release liner of the more peelable side was removed from each of the prepared double-coated pressure-sensitive adhesive sheets to expose a surface; a PET film 25 μm thick was affixed (lined) to the exposed surface; the other release liner of the less peelable side was then removed to expose another surface; this exposed surface was laid on the test plate; and a 2-kg rubber roller (about 45 mm wide) was placed thereon and moved in one reciprocating manner.

The measurement was conducted under conditions at a peel angle of 180 degrees and a tensile speed of 300 mm per minute in an atmosphere of a temperature of 23° C. and relative humidity of 50%, and an adhesive strength was calculated. The test was conducted a total of three times per specimen, and the average of the three measurements was defined as the adhesive strength of the specimen.

(2) Release Force of Release Liners

Strip sheet pieces 50 mm wide and 150 mm long were cut from the double-coated or double-sided pressure-sensitive adhesive sheets prepared according to the examples and comparative examples and used as test specimens for the measurement of a release force of the more peelable side. For the measurement of a release force of the less peelable side, the release liner of the more peelable side was removed, and a PET film 25 μm thick was affixed (lined) to the exposed surface to give test specimens.

Each of the test specimens was subjected to a 180-degree peel test using a tensile tester according to the method specified in JIS 20237 to measure a 180-degree peel strength (N/50 mm) of each release liner, and the measured 180-degree peel strength was defined as a “release force of release liner”.

The measurement was conducted under conditions at a peel angle of 180 degrees and a tensile speed of 300 mm per minute in an atmosphere of a temperature of 23° C. and relative humidity of 50%, and an adhesive strength was calculated. The test was conducted three times (n=3) per sample, and the average of the three measurements was defined as the release force.

Tests were conducted on both the release liners of the less peelable side and of the more peelable side. In the measurement of a release force of the release liner of the less peelable side, the adhesive face from which the release liner of the more peelable side had been removed was lined (backed) with a PET film, as described above.

(3) Split Distance (at 70° C. for 2 Hours)

Test specimens were prepared from each of the double-coated or double-sided pressure-sensitive adhesive sheets prepared according to the examples and comparative examples (size: 10 mm wide and 90 mm long) by removing a release liner of the more peelable side to expose an adhesive face, and affixing the exposed adhesive face (more peelable side) to an aluminum sheet 0.5 mm thick, 10 mm wide, and 90 mm long. The test specimens were bent in its longitudinal direction into an arc along a round rod having a diameter of 50 mm so that the pressure-sensitive adhesive sheet faced outward; the release liner of the less peelable side was removed from each test specimen to expose the adhesive face of the less peelable side; and this exposed adhesive face was affixed to an adherend through compression bonding using a laminator. The adherend was a sheet prepared by affixing a polyimide film “Kapton 100H” to a polypropylene (PP) sheet 2 mm thick through a pressure-sensitive adhesive tape, and the pressure-sensitive adhesive layer was affixed to the polyimide film of the adherend. The resulting article was left stand in an environment of 23° C. for 24 hours, thereafter heated at 70° C. for 2 hours, and the heights (mm) of both ends of the test specimen split and raised from the adherend surface were measured and averaged as a split distance (mm).

When adopted to a component which will be heated after affixation, double-coated pressure-sensitive adhesive sheets preferably have split distances determined as above of 1.5 mm or less.

(4) Processability

Test specimens for processability evaluation were prepared by half-cutting the double-coated or double-sided pressure-sensitive adhesive sheets prepared according to the examples and comparative examples from the release liner “b” side using a pressing machine, whereby only the release liner “b” and the pressure-sensitive adhesive unit were notched. The test specimens for processability evaluation were left in an atmosphere at a temperature of 60° C. and relative humidity of 90% for one week, and whether autohesion of the cut surfaces occurred was observed, and the processability (processing suitability) was evaluated according to the criteria mentioned below.

Regarding Comparative Example 1, the double-sided pressure-sensitive adhesive sheet was half-cut from the release liner of the less peelable side, and evaluation was conducted in the same manner as above.

Criteria for Processability

Good: No autohesion was observed at the cut surfaces.

Poor: Autohesion was observed at the cut surfaces.

(5) Fittability Around Bumps

The release liner of the more peelable side was removed from the double-coated or double-sided pressure-sensitive adhesive sheets prepared according to the examples and comparative examples (size: 40 mm wide and 40 mm long) to expose an adhesive face, and the exposed adhesive face was applied to a surface of a base film layer of a FPC mentioned below through compression bonding under conditions at a temperature of 60° C. and a pressing force of 2 MPa for 10 seconds. After compression bonding, the resulting article was observed from the double-coated pressure-sensitive adhesive sheet side with a microscope of 50 magnifications. A sample showing less “adhesion failures (lifting)” between the double-coated pressure-sensitive adhesive sheet and the base film layer typically in portions with bumps was evaluated as having good fittability around bumps; and one showing more “adhesion failures” was evaluated as having poor fittability around bumps.

Additionally, tests and evaluations were conducted by the above procedure, except for carrying out compression bonding at a temperature of 60° C. and a pressing force of 0.5 MPa for 10 seconds.

FPC (Adherend)

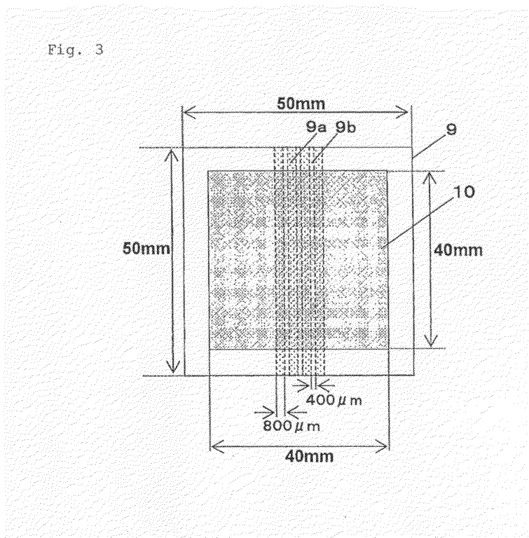

FIG. 2 is an explanatory drawing (schematic cross-sectional view) of a multilayer structure of the FPC used as the adherend above. FIG. 3 is an explanatory drawing (plan view when viewed from the base film layer side) illustrating how and where the double-coated pressure-sensitive adhesive sheet (test sample) was affixed to the FPC.

The FPC structurally includes a base insulating layer; a copper foil layer (conductor layer) 6 present on the base insulating layer; and a covering insulating layer present on the copper foil layer 6. The base insulating layer has a multilayer structure including a polyimide base film layer 4 and an epoxy adhesive layer 5. The covering insulating layer has a multilayer structure including a polyimide cover-lay film layer 8 and an epoxy adhesive layer 7. The base film layer 4 has a thickness of 0.025 mm, the adhesive layer 5 has a thickness of 0.015 mm, the copper foil layer 6 has a thickness of 0.035 mm, the cover-lay adhesive layer 7 has a thickness of 0.025 mm, and the cover-lay film layer 8 has a thickness of 0.025 mm.

The copper foil layer is formed so as to have four linear circuit traces each having a width of the copper foil (line width) of 800 μm and a width of a space between adjacent copper foils of 400 μm. The surface of the base film layer of the FPC has bumps (steps) caused by the copper foil lines and spaces between the copper foil lines in the copper foil layer.

The double-coated pressure-sensitive adhesive sheet (test sample) 10 was affixed to the surface of the base film layer of the FPC (adherend) 9 as illustrated in FIG. 3. In FIG. 3, the reference numerals “9a” stands for a portion where the copper foil is arranged, and “9b” stands for a portion where the copper foil is not arranged.

TABLE 1

| | | Example 1 | Example 2 | Example 3 | Com. Ex. 1 | Com. Ex. 2 | Com. Ex. 3 |
|---|---|---|---|---|---|---|---|
| Plastic base film (thickness) | | PET film | PET film | PET film | None | PET film | PET film |
| | | (12 μm) | (25 μm) | (50 μm) | | (16 μm) | (12 μm) |
| Pressure-sensitive | Acrylic polymer | Acrylic | Acrylic | Acrylic | Acrylic | Acrylic | Acrylic |
| adhesive layer | | Polymer 1 | Polymer 1 | Polymer 1 | Polymer 2 | Polymer 1 | Polymer 1 |
| | Amount of epoxy crosslinking agent (part | 0.01 | 0.01 | 0 | 0 | 0.01 | 0.01 |
| | by weight) | | | | | | |
| | Amount of isocyanate crosslinking agent | 0.2 | 0.2 | 0.3 | 2 | 0.2 | 0.2 |
| | (part by weight) | | | | | | |
| | Thickness of pressure sensitive layer (one | 24 | 37.5 | 50 | — | 17 | 19 |
| | layer) (μm) | | | | | | |

| Thickness of pressure-sensitive adhesive unit (μm) | | 60 | 100 | 150 | 50 | 50 | 50 |
|---|---|---|---|---|---|---|---|
| Release liner | | Non- | Non- | Non- | Silicone, | Non- | Non- |
| | | silicone, | silicone, | silicone, | both sides | silicone, | silicone, |
| | | both sides | both sides | both sides | | both sides | both sides |
| Gel fraction (%) of pressure-sensitive adhesive layers | | 40 | 40 | 18 | 70 | 40 | 40 |
| Adhesive strength (N/20 mm) (180-degree peel, to SUS | | 11 | 12 | 7.9 | 8.6 | 6 | 9 |
| 304-BA steel plate) | | | | | | | |
| Release force of release | More peelable side (N/50 mm)) | 0.2 | 0.2 | 0.2 | 0.1 | 0.15 | 0.16 |
| liners | Less peelable side (N/50 mm) | 1 | 1.2 | 0.9 | 0.3 | 0.8 | 0.93 |
| Split distance (mm) (at 70° C. for 2 hr) | | 0.5 | 0.5 | 0.9 | 1.3 | 1.2 | 0.5 |
| Processability | | Good | Good | Good | Poor | Good | Good |
| Fittability around bumps | 60° C., 2 MPa, 10 sec. | Good | Good | Good | Good | Poor | Good |
| | 60° C., 0.5 MPa, 10 sec. | Good | Good | Good | Good | Poor | Poor |

Acrylic Polymer 1: Butyl acrylate (93 parts by weight)/acrylic acid (7 parts by weight)/hydroxybutyl acrylate (0.05 part by weight), with azobisisobutyronitrile initiator
Acrylic Polymer 2: 2-Ethylhexyl acrylate (90 parts by weight)/acrylic acid (10 parts by weight) with benzoyl peroxide initiator
Epoxy crosslinking agent: trade name “TETRAD-C” supplied by Mitsubishi Gas Chemical Company, Inc.
Isocyanate crosslinking agent: trade name “Coronate L” supplied by Nippon Polyurethane Industry Co., Ltd.

The evaluation results in Table 1 demonstrate as follows. The double-coated pressure-sensitive adhesive sheets according to embodiments of the present invention (Examples 1 to 3) excel both in processability and fittability around bumps. In addition, they have gel fractions of pressure-sensitive adhesive layers within a range of from 10% to 60%, are resistant to “lifting” even when stored at elevated temperatures for a long duration, and are thereby advantageously usable even in applications where the sheets affixed to adherends are subjected to a hearting or warming process.

In contrast, the base-less pressure-sensitive adhesive sheet according to Comparative Example 1, using no plastic base film, is inferior in processability. The pressure-sensitive adhesive sheets according to Comparative Example 2 and Comparative Example 3, having thicknesses of the pressure-sensitive adhesive unit and of the pressure-sensitive adhesive layers smaller than the specific ranges, do not satisfactorily fit around bumps.

While the above description is of the preferred embodiments of the present invention, it should be appreciated that the invention may be modified, altered, or varied without deviating from the scope and fair meaning of the following claims.

1. A double-coated pressure-sensitive adhesive sheet for fixing a flexible printed circuit board, the adhesive sheet comprising at least:
a pressure-sensitive adhesive unit including
a plastic base film,
a first pressure-sensitive adhesive layer present on or above one surface of the plastic base film and forming a first surface of the pressure-sensitive adhesive unit, and
a second pressure-sensitive adhesive layer present on or above the other surface of the plastic base film and forming a second surface of the pressure-sensitive adhesive unit;
a first non-silicone release liner present on the first surface of the pressure-sensitive adhesive unit; and
a second non-silicone release liner present on the second surface of the pressure-sensitive adhesive unit,
wherein each of the first and second pressure-sensitive adhesive layers independently includes an acrylic polymer containing, as essential monomer components, one or more polar-group-containing monomers and one or more alkyl (meth)acrylates whose alkyl moiety being a linear or branched-chain alkyl group having 2 to 14 carbon atoms,
wherein the pressure-sensitive adhesive unit has a thickness of from 60 to 160 μm, and
wherein each of the first and second pressure-sensitive adhesive layers independently has a thickness of 20 μm or more.

2. A double-coated pressure-sensitive adhesive sheet for fixing a hard disk drive component, the adhesive sheet comprising at least:
a pressure-sensitive adhesive unit including
a plastic base film,
a first pressure-sensitive adhesive layer present on or above one surface of the plastic base film and forming a first surface of the pressure-sensitive adhesive unit, and
a second pressure-sensitive adhesive layer present on or above the other surface of the plastic base film and forming a second surface of the pressure-sensitive adhesive unit;
a first non-silicone release liner present on the first surface of the pressure-sensitive adhesive unit; and
a second non-silicone release liner present on the second surface of the pressure-sensitive adhesive unit,
wherein each of the first and second pressure-sensitive adhesive layers independently includes an acrylic polymer containing, as essential monomer components, one or more polar-group-containing monomers and one or more alkyl (meth)acrylates whose alkyl moiety being a linear or branched-chain alkyl group having 2 to 14 carbon atoms,
wherein the pressure-sensitive adhesive unit has a thickness of from 60 to 160 μm, and
wherein each of the first and second pressure-sensitive adhesive layers independently has a thickness of 20 μm or more.

3. The double-coated pressure-sensitive adhesive sheet according to claim 1, wherein each of the first and second pressure-sensitive adhesive layers independently has a thickness of from 20 to 60 μm.

4. The double-coated pressure-sensitive adhesive sheet according to claim 1, wherein each of the first and second pressure-sensitive adhesive layers independently has a gel fraction of from 10% to 60%.

5. The double-coated pressure-sensitive adhesive sheet according to claim 1, wherein the first and second non-silicone release liners are polyolefinic release liners.

6. The double-coated pressure-sensitive adhesive sheet according to claim 2, wherein each of the first and second pressure-sensitive adhesive layers independently has a thickness of from 20 to 60 μm.

7. The double-coated pressure-sensitive adhesive sheet according to claim 2, wherein each of the first and second pressure-sensitive adhesive layers independently has a gel fraction of from 10% to 60%.

8. The double-coated pressure-sensitive adhesive sheet according to claim 3, wherein each of the first and second pressure-sensitive adhesive layers independently has a gel fraction of from 10% to 60%.

9. The double-coated pressure-sensitive adhesive sheet according to claim 6, wherein each of the first and second pressure-sensitive adhesive layers independently has a gel fraction of from 10% to 60%.

10. The double-coated pressure-sensitive adhesive sheet according to claim 2, wherein the first and second non-silicone release liners are polyolefinic release liners.

11. The double-coated pressure-sensitive adhesive sheet according to claim 3, wherein the first and second non-silicone release liners are polyolefinic release liners.

12. The double-coated pressure-sensitive adhesive sheet according to claim 4, wherein the first and second non-silicone release liners are polyolefinic release liners.

13. The double-coated pressure-sensitive adhesive sheet according to claim 6, wherein the first and second non-silicone release liners are polyolefinic release liners.

14. The double-coated pressure-sensitive adhesive sheet according to claim 7, wherein the first and second non-silicone release liners are polyolefinic release liners.

15. The double-coated pressure-sensitive adhesive sheet according to claim 8, wherein the first and second non-silicone release liners are polyolefinic release liners.

16. The double-coated pressure-sensitive adhesive sheet according to claim 9, wherein the first and second non-silicone release liners are polyolefinic release liners.
